(19) United States
(12) Patent Application Publication
(10) Pub. No.: US 2023/0274871 A1
(43) Pub. Date: Aug. 31, 2023

(54) TRANSFORMER CORE AND TRANSFORMER

(71) Applicant: HITACHI ENERGY SWITZERLAND AG, Baden (CH)

(72) Inventors: Luigi de-Mercato, Varese (IT); Seung-Chul Lee, Asan-si (KR); Jong-Min Leem, Cheonansi (KR)

(21) Appl. No.: 18/015,755

(22) PCT Filed: Aug. 3, 2021
(86) PCT No.: PCT/EP2021/071617

§ 371 Date: Jan. 12, 2023

(30) Foreign Application Priority Data
Aug. 6, 2020 (EP) 20189858.2

(51) Int. Cl. H01F 27/26; H01F 27/33

(52) U.S. Cl. CPC H01F 27/263; H01F 27/33

(57) ABSTRACT

A transformer core, comprising a first yoke, a second yoke, a column (6) having a column main axis (8) and extending between the first yoke and the second yoke, and an elongate clamping structure (10) comprising an elongate rigid member (12) having a rigid member main axis (14) is provided. The column (6) includes an elongate opening (16) having an opening main axis (18) which is oriented transversal with respect to the column main axis (8). The rigid member (12) is positioned within the elongate opening (16) such that the rigid member main axis (14) is oriented parallel to the opening main axis (18).

### CROSS REFERENCE TO RELATED APPLICATIONS

This application is a U.S.C. § 371 national stage application of PCT International Application No. PCT/EP2021/071617 filed on Aug. 3, 2021, which in turn claims priority to European Application No. 20189858.2, filed on Aug. 6, 2020, the disclosures and content of which are incorporated by reference herein in their entireties.

### BACKGROUND

The present disclosure relates to a transformer core and, more particularly, to a transformer core having an improved stiffness. Further, the disclosure relates to a transformer comprising such a transformer core.

A conventional transformer typically comprises windings mounted on cores of ferromagnetic material. The cores are connected at its lower ends to a bottom yoke and at its upper ends to a top yoke. The yokes and the columns are typically assembled as a stack of magnetic sheets, e.g. grain-oriented or grain-not-oriented magnetic sheets. Further, it is known to use a frame for clamping and compressing the bottom yoke together and the top yoke together.

However, in certain cases of dynamic loads, for example vibrational loads caused by a seismic activity, the structure of the transformer assembly, i.e. the “transformer frame structure” may be displaced in such a way that high stress levels acting on critical parts of the assembly may arise. This may result in fatigue and crack propagation mechanisms and a failure of the transformer. Corresponding loads may occur for example in case of a transformer used in the field of nuclear power, wind power, marine and other industries.

There is a need to provide improved techniques for reducing the risk of a failure of a transformer. There is particularly a need for techniques that mitigate the risk of crack formations in a transformer frame structure. These objects are achieved by the independent claims. Dependent claims refer to additional embodiments.

### SUMMARY

According to some embodiments of the present disclosure, a transformer core, comprising a first yoke, a second yoke, a column having a column main axis and extending between the first yoke and the second yoke, and an elongate clamping structure comprising an elongate rigid member having a rigid member main axis may be provided. The column includes an elongate opening having an opening main axis which is oriented transversal with respect to the column main axis. The rigid member is positioned within the elongate opening such that the rigid member main axis is oriented parallel to the opening main axis.

The elongate clamping structure may allow for effectuating a controllable stiffness of the column. In this manner the mechanical properties of the column and of the whole transformer core can be controlled or influenced. The stiffness of the column may significantly influence the dynamic response of the transformer core and the dynamic response of the transformer to external loads such as vibrational or shock loads. Further, it may influence the quality of a noise generated by the transformer core in response to such loads. More specifically, the elongate clamping structure may allow for effectuating an enlarged stiffness of the transformer core resulting in an improved response behavior of the transformer to external loads.

The stiffness of the transformer core may play a significant role in the dynamic response of the transformer, particularly to vibrational loads. The structural stiffness of the transformer core may directly influence the mechanical resonance behavior of the transformer core and the corresponding relevant mode shapes. Generally, a low mechanical overall resonance frequency may lead to large displacements of the structure during vibration, and therefore to high stress levels on critical parts of the transformer frame structure. The stiffness and compactness of the columns of the core may be primary factors with respect to the lowest and dominant mechanical resonances of the core. This may be due to the ratio between the stiffness and the mass of a column which is insofar unfavorable. One mode of vibration involves a longitudinal bending of the columns, as schematically sketched in FIGS. 2a and 2b illustrating a side view of a transformer. The elongate clamping structure may allow for achieving an increased flexural stiffness of the column and in this manner increased mechanical resonance frequencies of the transformer core resulting in reduced stress levels. Thus, a reduced risk of a failure of the transformer can be achieved.

Various embodiments may also implement the following features:

The column may include a stack of sheets, e.g. grain-oriented or grain-not-oriented sheets. The elongate clamping structure is particularly suited in such a case, since it allows for reducing movements of the sheets relative to each other.

The elongate clamping structure may include a first end portion and an opposing second end portion, wherein the first and second end portions are configured to compress a portion of the column which surrounds the elongate clamping structure. This may allow for effectuating a force which compresses or tightens the column. In this manner, the stiffness of the column can be further improved.

The first end portion and/or the second end portion of the elongate clamping structure may include a fixing member having a conical shaped head portion. The conical shaped head portion helps generating a specifically effective compressing force.

The fixing member for example may include or be formed by a countersunk bolt.

The elongate opening may include at least one conical end portion which is shaped correspondent to the conical shaped head portion of the fixing member, wherein the transformer core may be designed such that the conical shaped head portion of the fixing member is positioned completely within the elongate opening. Thus, an adverse effect of the fixing member on windings of a coil of the transformer which is wound about the column can be excluded or at least mitigated.

The column may include at least one leg plate extending parallel to the column main axis, wherein the at least one conical end portion of the elongate opening is formed in the at least one leg plate.

The fixing member may include a screw which is screwable connected to the rigid member. This allows for achieving a controllable compressive force acting on the column in a particularly suitable and easy to handle manner Moreover, this facilitates assembling of the transformer core.

The transformer core may further include at least one washer positioned around the conical shaped head portion of the fixing member.

The washer may be of insulating material. This may allow for mitigating the risk of damaging parts of the transformer core during assembly.

The elongate clamping structure may include an insulation tube which is positioned between the rigid member and an inner surface of the elongate opening and configured to effectuate an isolation between the rigid member and the column. The insulation tube may be a flexible insulation tube.

The washer may be formed as a part of the insulation tube. In other words, the insulation tube may to the outer end of the conical shaped head portion of the fixing member.

The insulation tube may be designed such that it ends flush with a surrounding outer surface section of the column directly adjacent to the conical end portion of the elongate opening. Alternatively, the washer may be positioned between the conical shaped head portion of the fixing member and the insulation tube. The insulation tube and the washer may be formed such that they do not protrude above the surrounding outer surface section of the column.

The transformer core may include at least one further elongate clamping structure which is constructed analog to the first mentioned elongate clamping structure. The elongate rigid member of the at least one further elongate clamping structure may be oriented parallel to the elongate rigid member of the first mentioned elongate clamping structure. The at least one further elongate clamping structure may allow for effectuating a further improved stiffness and compactness of the column.

For example, at least three elongate clamping structures may be provided such that a row of elongate clamping structures along the column is formed, comprising a first elongate clamping structure, a second elongate clamping structure, and a third elongate clamping structure, in that order, wherein a first distance between the first and the second elongate clamping structures differs from a second distance between the second and the third elongate clamping structures. This may allow for achieving a certain level of stiffness and compactness of the column by a particularly small number of elongate clamping structures.

The row of elongate clamping structures may be formed such that the distances between the elongate clamping structures increase with increasing distance form the first yoke, wherein the first yoke is a bottom yoke and the second yoke is an upper yoke.

The transformer core may further include at least one further column, wherein a main axis of the at least one further column and the main axis of the first mentioned column are positioned within a common plane, and wherein the opening main axis of the elongate opening is further oriented normal to said plane.

The at least one further column may be constructed analog to the first mentioned column The at least one further column may include corresponding elongate openings, wherein rigid members of corresponding further elongate clamping structures are positioned within the elongate openings analogously.

According to a further aspect of the disclosure, a transformer comprising a transformer core according to the disclosure and a winding wound around the column may be provided.

### BRIEF DESCRIPTION OF THE DRAWINGS

The subject-matter of the disclosure will be explained in more detail with reference to exemplary embodiments which are illustrated in the attached drawings, in which:

FIG. 1 is a schematic frontal view of a transformer core comprising columns and yokes according to the disclosure.

FIGS. 2a and 2b are schematic side views of a transformer core illustrating a longitudinal bending of the columns.

FIG. 3 is a schematic cross-sectional view of an elongate clamping structure according to the disclosure.

FIG. 4 illustrates a variation of the elongate clamping structure of FIG. 3 comprising a separately formed washer.

### DETAILED DESCRIPTION

Example embodiments of the disclosure will be described with reference to the drawings in which identical or similar reference signs designate identical or similar elements. The features of embodiments may be combined with each other, unless specifically noted otherwise.

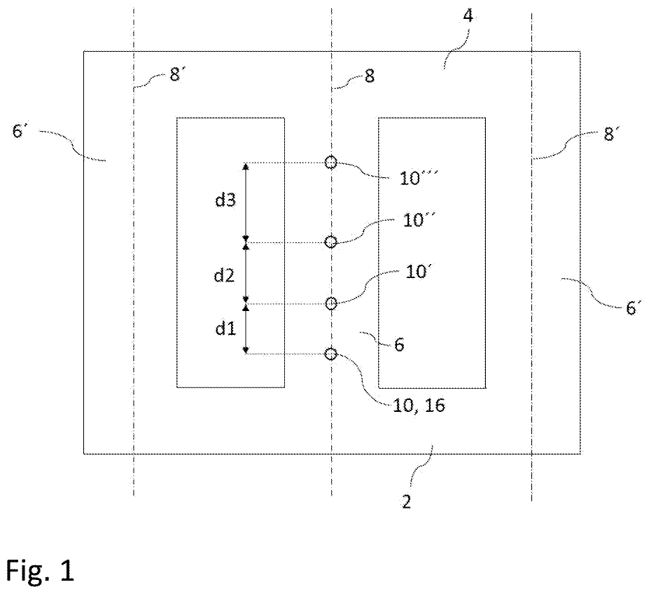

FIG. 1 is a schematic front view of a transformer core according to the disclosure. A transformer comprising the transformer core may be for example a distribution transformer. The transformer core comprises a first yoke 2, a second yoke 4, and a column 6. The first yoke 2 is a lower or bottom yoke and the second yoke 4 is an upper yoke. The column 6 extends between the first yoke 2 and the second yoke 4. The column 6 has a column main axis 8 which may be oriented at least essentially vertically. A cross-section of the column 6 normal to the column main axis 8 may be at least to a first approximation circular.

The transformer core further comprises at least one further column 6′, 6″, for example two further columns 6′, 6″, wherein a main axis 8′, 8″ of the at least one further column 6′, 6″ and the main axis 8 of the first mentioned column 6 are positioned within a common plane, for example a vertical plane. The at least one further column 6′, 6″ may be constructed analog to the first mentioned column 6. The transformer comprises the transformer core according to the disclosure and windings wound around each one of the columns 6, 6, 6″.

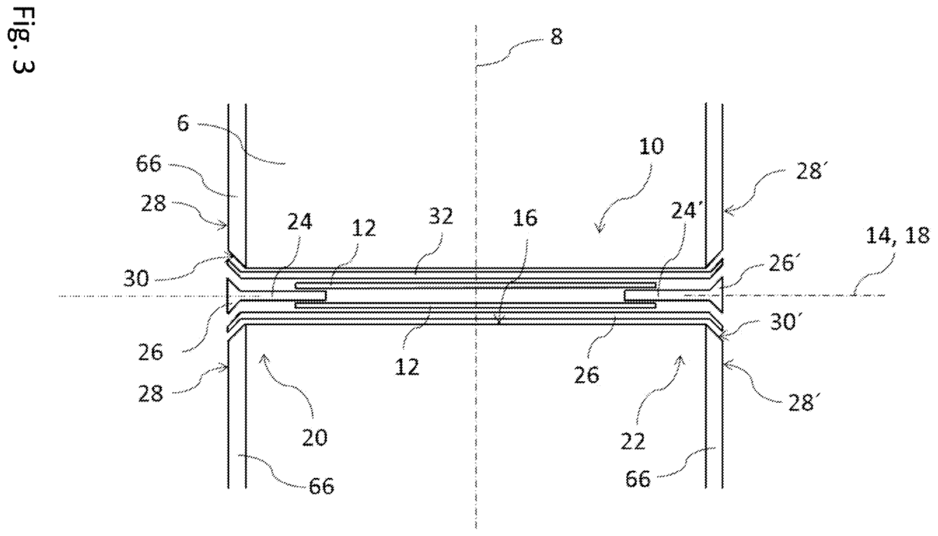

The transformer core further comprises an elongate clamping structure 10. FIG. 3 is a schematic cross-sectional view of the elongate clamping structure 10 and a surrounding portion of the column 6. Note that FIG. 3 shows the distances between corresponding parts enlarged simply for improved recognizability. The cross-section of FIG. 3 is taken perpendicular to the common plane in which the main axes 8, 8′, 8″ of the columns 6, 6′, 6″ are positioned, i.e. in a plane perpendicular to the drawing plane of FIG. 1.

The elongate clamping structure 10 comprises an elongate rigid member 12 having a rigid member main axis 14. The rigid member 12 may be made of a material comprising a metal, particularly steel. The rigid member 12 may be tube shaped, for example in the form of a hollow-core bolt. For example, the rigid member 12 is a steel pipe in the form of a hollow-core bolt.

The column 6 includes an elongate opening 16 having an opening main axis 18 which is oriented transversal, for example perpendicular with respect to the column main axis 8. The opening main axis 18 may be oriented horizontally. The rigid member 12 is positioned within the elongate opening 16 such that the rigid member main axis 14 is oriented parallel to the opening main axis 18.

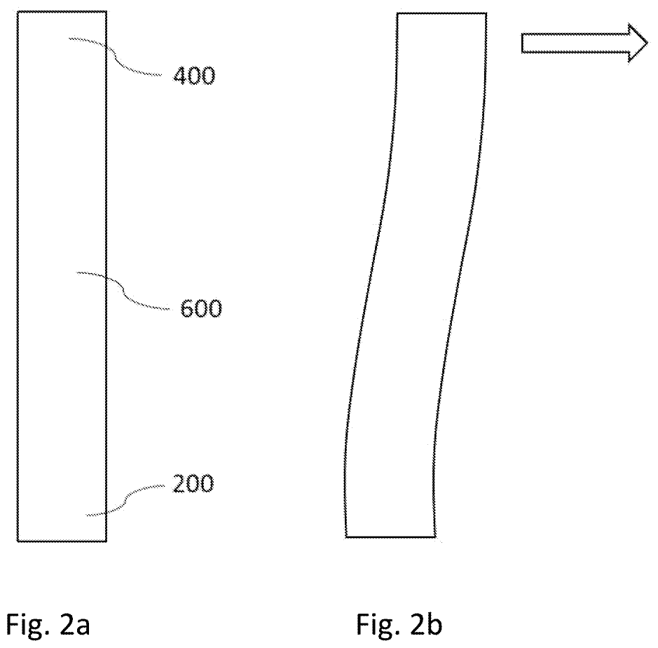

FIGS. 2a and 2b are schematically illustrated side views of a prior art transformer core illustrating generally an effect of a load acting on the transformer core. The transformer core comprises a bottom yoke 200, a column 600, and an upper yoke 400. FIG. 2a illustrates a state of the transformer core without the load acting on the transformer core, FIG. 2b a state with the load acting on the transformer core, as indicated by an arrow. The load leads to a deformation of the transformer core as shown in FIG. 2b which is generally unwanted since it involves an increased risk of a crack mechanism potentially leading to a failure of the transformer, as outlined above. According to the present disclosure, the stiffness of the column and of the transformer core can be suitably increased under use of the elongate clamping structure in such a way that a corresponding unwanted deformation of the transformer core can be prevented.

The elongate rigid member 12 may be designed such that it extends over at least 80%, or at least 90% of the length of the elongate opening 16. Both ends of the elongate rigid member 12 may not protrude beyond an outer surface of the column 6.

The elongate clamping structure 10 comprises a first end portion and an opposing second end portion 22. The first and second end portions 20, 22 are configured to compress a portion of the column 6 which surrounds the elongate clamping structure 10. To this end the first end portion and/or the second end portion 22 of the elongate clamping structure 10 comprises a fixing member 24, 24′ having a conical shaped head portion 26, 26′. The fixing member 24, 24′ may be a countersunk bolt. The fixing member 24, 24′ may include or be formed of a screw which is screwable connected to the rigid member 12, for example screwed into the rigid member 12 having the form of a hollow-core bolt. This enables easy connecting the elongate clamping structure 10 to the column 6 during assembly of the transformer core.

The elongate opening 16 comprises at least one conical end portion 30, 30′ which is shaped correspondent to the conical shaped head portion 26, 26′ of the fixing member 24, 24′. This allows for an easy and fine adjustment of a compressive force acting on the column 6 that is generated by the fixing members 24 in combination with the elongate rigid member 12.

The column 6 comprises at least one leg plate 66 extending parallel to the column main axis 8, wherein the at least one conical end portion 30, 30′ is formed in the at least one leg plate 66. For example, the leg plate 66 forms an outer surface of the column 6. In particular, the column 6 comprises a stack of sheets, wherein an inner surface of the at least one leg plate 66 abuts the stack of sheets. For example, as sketched in FIG. 3, the column 6 comprises two leg plates 66 disposed on opposing sides of the column 6 with respect to the column main axis 8.

The transformer core may be designed such that the conical shaped head portion 26, 26′ of the fixing member 24, 24′ is positioned completely within the elongate opening 16. Accordingly, an interference of a winding of a coil wound around the column 6 with the elongate clamping structure 10 can be precluded or at least mitigated.

The elongate clamping structure 10 may further include an insulation tube 32 which is positioned between the rigid member 12 and an inner surface of the elongate opening 16 and configured to effectuate an isolation between the rigid member 12 and the column 6. For example, the insulation tube 32 is made from a material comprising Polytetrafluorethylene (PTFE). The insulation tube 32 may be a PTFE-tube.

The transformer core may further comprise at least one washer positioned around the conical shaped head portion 26, 26′ of the fixing member 24, 24′. The at least one washer may be arranged between the head portion 26, 26′ of the fixing member 26, 26′ and the conical end portion 30, 30′ of the elongate opening 16.

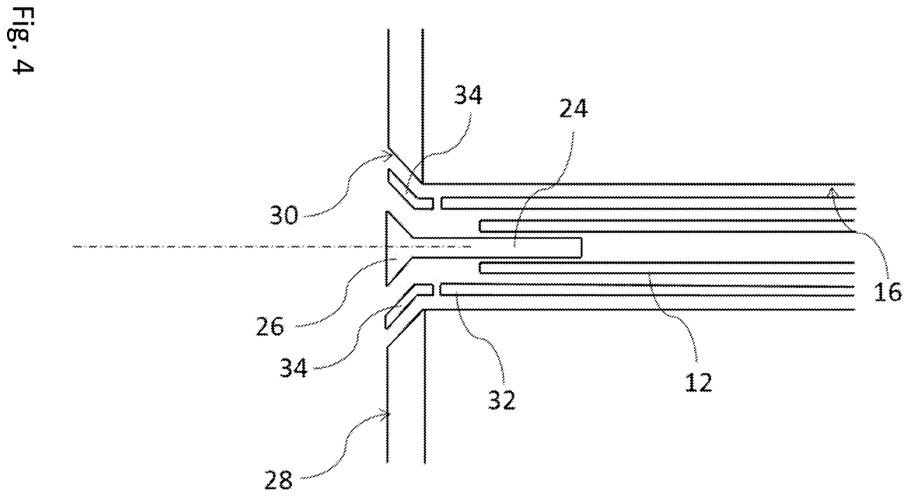

The at least one washer may be associated with the insulation tube 32 or formed as a part of the insulation tube 32. Alternatively, as sketched in the cross-sectional view of FIG. 4, the at least one washer—here indicated by reference sign 34—may be an insulating washer arranged between the head portion 26, 26′ and a surface of the conical end portion 30, 30′ of the elongate opening 16. This reduces the risk of damaging the insulation tube 32 during assembly, for example during tightening the fixing members 26, 26′.

The transformer core may further include at least one further elongate clamping structure 10′, 10″, 10″′ as exemplarily sketched in FIG. 1, which is constructed analog to the first mentioned elongate clamping structure 10. The elongate rigid member of the at least one further elongate clamping structure 10′, 10″, 10″′ may be oriented parallel to the elongate rigid member 12 of the first mentioned elongate clamping structure 10.

For example, the transformer core comprises at least three elongate clamping structures 10, 10′, 10″, 10″′ such that a row of elongate clamping structures along the column 6 is formed, comprising a first elongate clamping structure 10, a second elongate clamping structure 10′, and a third elongate clamping structure 10″, in that order. A first distance d₁ between the first and the second elongate clamping structures 10, 10′ differs from a second distance d₂ between the second and the third elongate clamping structures 10′, 10″. According to the illustrated embodiment the row of elongate clamping structures 10, 10′, 10″, 10″′ is formed such that the distances d₁, d₂, d₃ between the elongate clamping structures 10, 10′, 10″, ″′increase with increasing distance form the first yoke 2. For example, the distances dᵢ may be chosen such that dᵢ₊₁=dᵢxᵢ, where i=1, 2, 3, . . . with 1.05≤xᵢ<1.5 and xᵢ₊₁>xᵢ.

While the disclosure has been described in detail in the drawings and forgoing description, such description is to be considered illustrative or exemplary and not restrictive. Variations to the disclosed embodiments can be understood and effected by those skilled in the art and practicing the claimed disclosure, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. Transformer core, comprising:
a first yoke,
a second yoke,
a column having a column main axis and extending between the first yoke and the second yoke, and
an elongate clamping structure comprising an elongate rigid member having a rigid member main axis,
the column including an elongate opening having an opening main axis which is oriented transversal with respect to the column main axis,
the rigid member positioned within the elongate opening such that the rigid member main axis is oriented parallel to the opening main axis,
the elongate clamping structure comprising a first end portion and an opposing second end portion, wherein the first and second end portions are configured to compress a portion of the column which surrounds the clamping structure,
the first end portion and/or the second end portion of the elongate clamping structure comprising a fixing member having a conical shaped head portion,
the transformer core further comprising at least one washer positioned around the conical shaped head portion of the fixing member,
the elongate clamping structure further comprising an insulation tube which is positioned between the rigid member and an inner surface of the elongate opening and configured to effectuate an isolation between the rigid member and the column,
the washer formed as a part of the insulation tube.

2. The transformer core according to claim 1, wherein the elongate opening comprises at least one conical end portion which is shaped correspondent to the conical shaped head portion of the fixing member, wherein the transformer core is designed such that the conical shaped head portion of the fixing member is positioned completely within the elongate opening.

3. The transformer core according to claim 1, wherein the fixing member comprises a screw which is screwable connected to the rigid member.

4. The transformer core according to claim 1, wherein the at least one washer is made from an electrically insulating material.

5. The transformer core according to claim 1, further comprising at least one further elongate clamping structure which is constructed analog to the first mentioned elongate clamping structure.

6. The transformer core according to claim 5, comprising at least three elongate clamping structures such that a row of elongate clamping structures along the column is formed, comprising a first elongate clamping structure, a second elongate clamping structure, and a third elongate clamping structure, in that order, wherein a first distance between the first and the second elongate clamping structures differs from a second distance between the second and the third elongate clamping structures.

7. The transformer core according to claim 6, wherein the row of elongate clamping structures is formed such that the distances between the elongate clamping structures increase with increasing distance form the first yoke.

8. The transformer core according to claim 1, further comprising at least one further column, wherein a main axis of the at least one further column and the main axis of the first mentioned column are positioned within a common plane, and wherein the opening main axis of the elongate opening is further oriented normal to said plane.

9. The transformer core according to claim 8, wherein the at least one further column is constructed analog to the first mentioned column.

10. A transformer, comprising:
a transformer core comprising:
a first yoke,
a second yoke,
a column having a column main axis and extending between the first yoke and the second yoke, and
an elongate clamping structure comprising an elongate rigid member having a rigid member main axis,
the column including an elongate opening having an opening main axis which is oriented transversal with respect to the column main axis,
the rigid member positioned within the elongate opening such that the rigid member main axis is oriented parallel to the opening main axis,
the elongate clamping structure comprising a first end portion and an opposing second end portion, wherein the first and second end portions are configured to compress a portion of the column which surrounds the clamping structure,
the first end portion and/or the second end portion of the elongate clamping structure comprising a fixing member having a conical shaped head portion,
the transformer core further comprising at least one washer positioned around the conical shaped head portion of the fixing member,
the elongate clamping structure further comprising an insulation tube which is positioned between the rigid member and an inner surface of the elongate opening and configured to effectuate an isolation between the rigid member and the column,
the washer formed as a part of the insulation tube; and
a winding wound around the column.

11. The transformer according to claim 10, wherein the elongate opening comprises at least one conical end portion which is shaped correspondent to the conical shaped head portion of the fixing member, wherein the transformer core is designed such that the conical shaped head portion of the fixing member is positioned completely within the elongate opening.

12. The transformer according to claim 10, wherein the fixing member comprises a screw which is screwable connected to the rigid member.

13. The transformer according to claim 10, wherein the at least one washer is made from an electrically insulating material.

14. The transformer according to claim 10, the transformer core further comprising at least one further elongate clamping structure which is constructed analog to the first mentioned elongate clamping structure.

15. The transformer according to claim 14, the transformer core further comprising at least three elongate clamping structures such that a row of elongate clamping structures along the column is formed, comprising a first elongate clamping structure, a second elongate clamping structure, and a third elongate clamping structure, in that order, wherein a first distance between the first and the second elongate clamping structures differs from a second distance between the second and the third elongate clamping structures.

16. The transformer according to claim 15, wherein the row of elongate clamping structures is formed such that the distances between the elongate clamping structures increase with increasing distance form the first yoke.

17. The transformer according to claim 1, the transformer core further comprising at least one further column, wherein a main axis of the at least one further column and the main axis of the first mentioned column are positioned within a common plane, and wherein the opening main axis of the elongate opening is further oriented normal to said plane.

18. The transformer according to claim 17, wherein the at least one further column is constructed analog to the first mentioned column.

19. The transformer core of claim 5, wherein the elongate rigid member of the at least one further elongate clamping structure is oriented parallel to the elongate rigid member of the first mentioned elongate clamping structure.

20. The transformer core of claim 7, wherein the first yoke is a bottom yoke and the second yoke is an upper yoke.
